(19) United States
(12) Patent Application Publication
(10) Pub. No.: US 2009/0261209 A1
(43) Pub. Date: Oct. 22, 2009

(54) CONVERTIBLE AIRCRAFT

(76) Inventor: Pavel Mioduchevski, Brindisi (IT)

Correspondence Address: Steinfl & Bruno, 301 N Lake Ave Ste 810, Pasadena, CA, 91101, US

(21) Appl. No.: 12/294,027

(22) PCT Filed: Mar. 26, 2007
(86) PCT No.: PCT/IB07/51049

§ 371 Date: Jun. 3, 2009

(30) Foreign Application Priority Data
Mar. 24, 2006 (IT) BR2006A000004

(51) Int. Cl. B64C 27/22; B64C 29/00

(52) U.S. Cl. 244/7 R

(57) ABSTRACT

A convertible aircraft comprising a main body integrating at least one substantially triangular wing (1), the main body having a recess (2) centered substantially in correspondence of the center of gravity of the aircraft; and a propulsion system associated to the main body so as to make it selectively pivoting within said recess (2) with respect to the main body, the propulsion system comprising a thrust rotor system (10,11); main motor means (33,9) for operating the thrust rotor system (10,11); and means (31,32) for adjusting the pivoting of the propulsion system with respect to the main body, apt to change the tilt of the thrust developed by the rotor system (10,11); wherein the overall assembly is such that the tilt of the axis of rotation of the rotor system (10,11) is variable in association with said pivoting so that the thrust instantaneously developed thereby is vectorially passing through the center of gravity of the aircraft.

The present invention relates to the field of general aviation and may be applied indiscriminately both to conventional aircrafts with onboard pilot and to highly automated aircrafts with no onboard pilot (unmanned) (UAV, UCAV, UAS)

In the aviation field it is known the convertible aircraft V22 Osprey, developed by Bell Helicopter Textron and Boeing aeronautic industries (Aviation Week & Space Technology, Jan. 2, 2006, page 56)

Moreover, Bell Helicopter-Textron have also developed an unmanned aircraft, UAS TR918 Eagle Eye, which has an aeromechanical scheme similar to the V22 Osprey (Aviation Week & Space Technology, Feb. 6, 2006, page 36).

The drawbacks of a V22 Osprey-type convertible aircraft are the following:
a) The two heavy engines are installed each at the wing ends, the span is equal to the distance between axes and engines; this fact requires great rigidity of the wing structure, considerably increasing the weight of the structure.
b) V22 Osprey engines and TR918 Eagle Eye rotors must be synchronized through a mechanical transmission placed in the wing structure, increasing the weight of the entire structure.
c) Engines and rotors are placed at the end of each wing. Engines, rotors and transmission are sources of powerful vibrations and noise.
d) The Osprey-type system does not ensure flight stability and safety in case of a rotor (engine) malfunctioning and/or breaking.
e) The span in this Osprey-type aeromechanical system must necessarily be not extended above a certain limit. If the span exceeds this limit the problem of aeroelastic vibrations becomes unsolvable.
f) The Osprey-type system is not capable of flying or landing at a relatively low speed, as a normal-scheme aircraft can do.

Object of the present invention is to solve the technical problems of the convertible aircraft and provide an aeromechanical scheme of the convertiplane as free from the abovementioned drawbacks.

Such a problem is mainly solved by an apparatus according to claim 1. The present invention provides several relevant advantages. One of the main advantages is that the invention increases the efficiency and the safety of the convertible aircraft. The present invention provides for the center of gravity of the engine with coaxial rotors to coincide with the center of gravity of the convertible aircraft. Span and wing surface of the convertiplane may be designed and built at the desired features: speed, distance and altitude of flight, of takeoff and of landing

Other advantages, features and the operation modes of the present invention will be made apparent from the following detailed description of some embodiments thereof, given by way of example and not for limitative purposes.

Reference will be made to the figures of the annexed drawings, wherein:

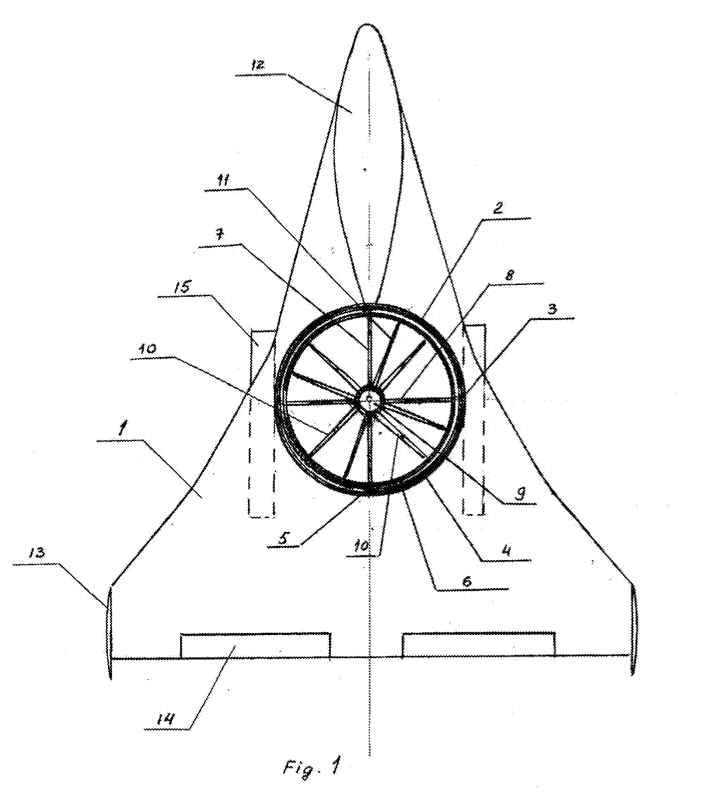

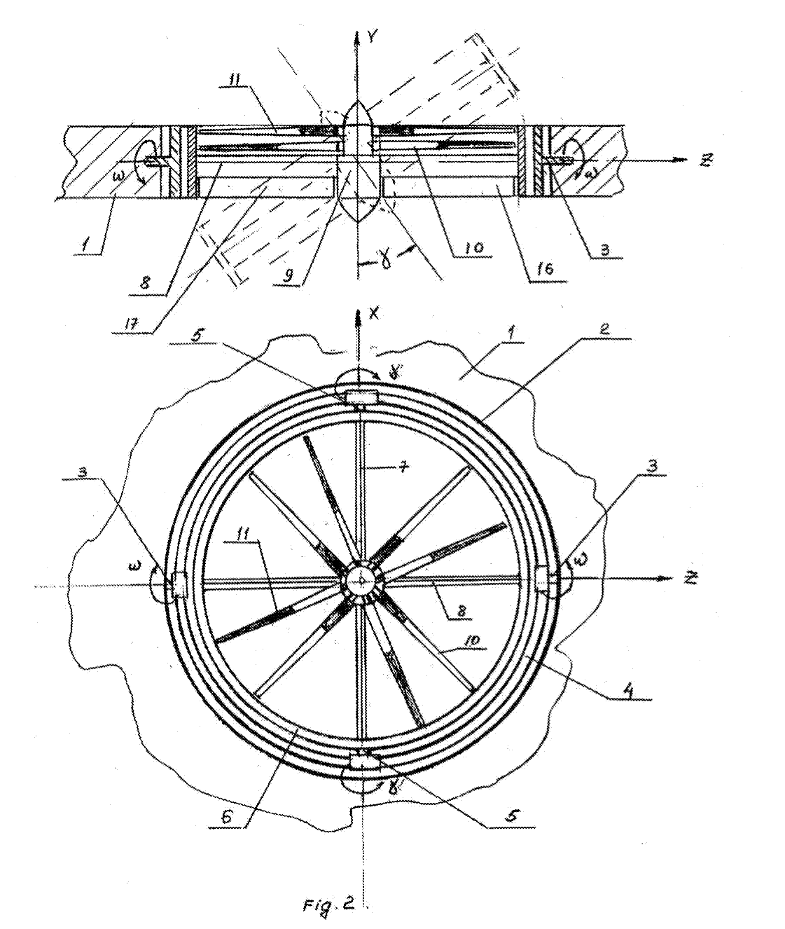

FIG. 1 shows a plan view of a first embodiment of triangular-wing convertible aircraft;

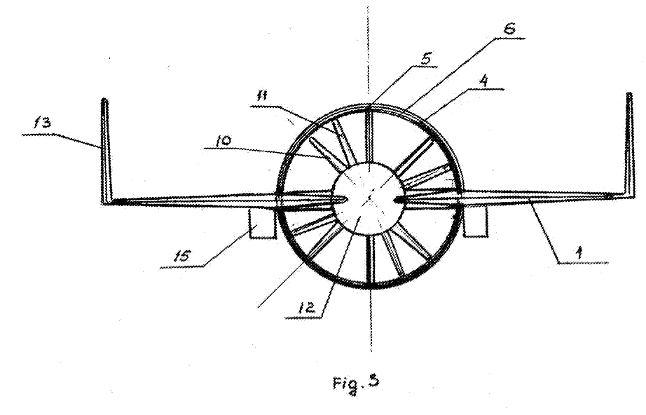

FIG. 2 shows a plan view and a cross-sectional view of the propulsion apparatus of the convertible aircraft;

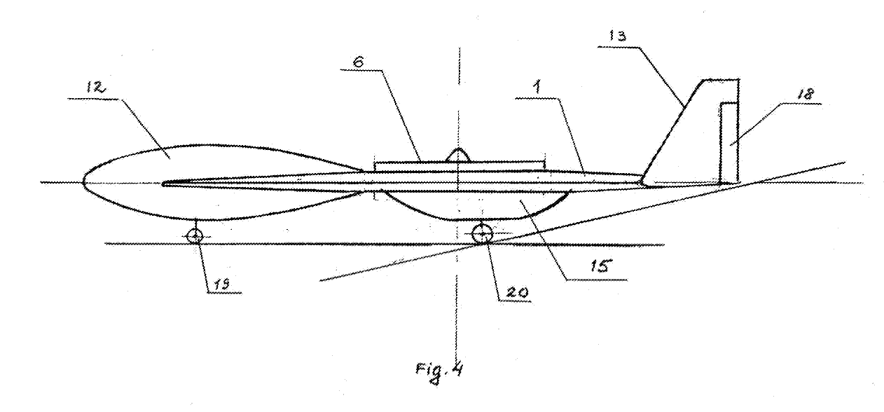

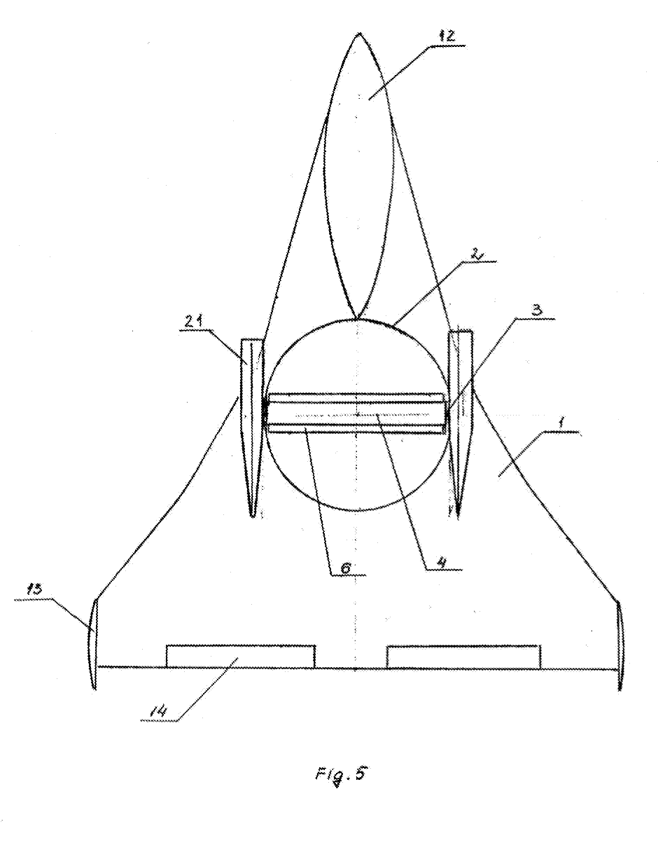

FIGS. 3 and 4 show respectively a front view and a side view of the convertible aircraft of FIG. 1;

FIG. 5 shows a plan view of a second embodiment of the triangular-wing convertible aircraft;

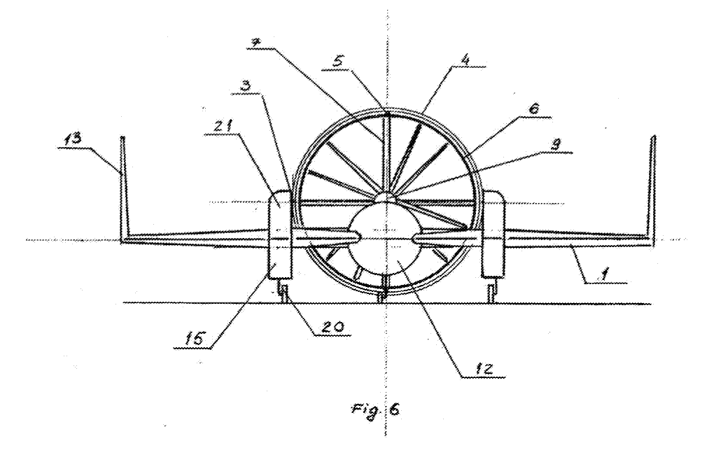

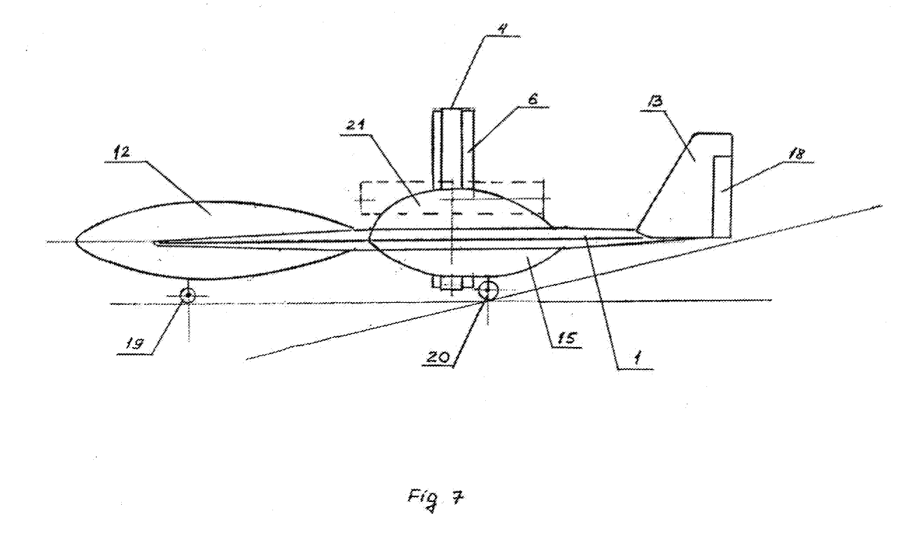

FIGS. 6 and 7 show respectively a front view and a side view of a second embodiment of the convertible aircraft of FIG. 5;

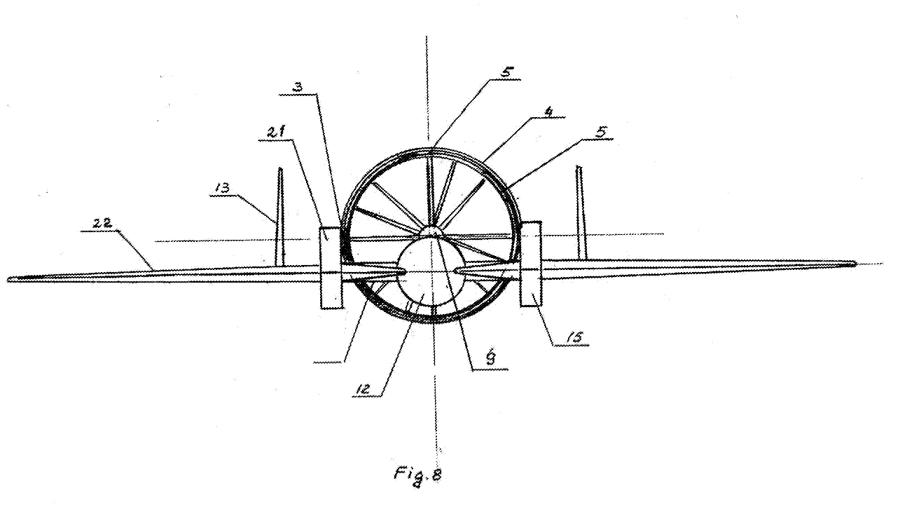

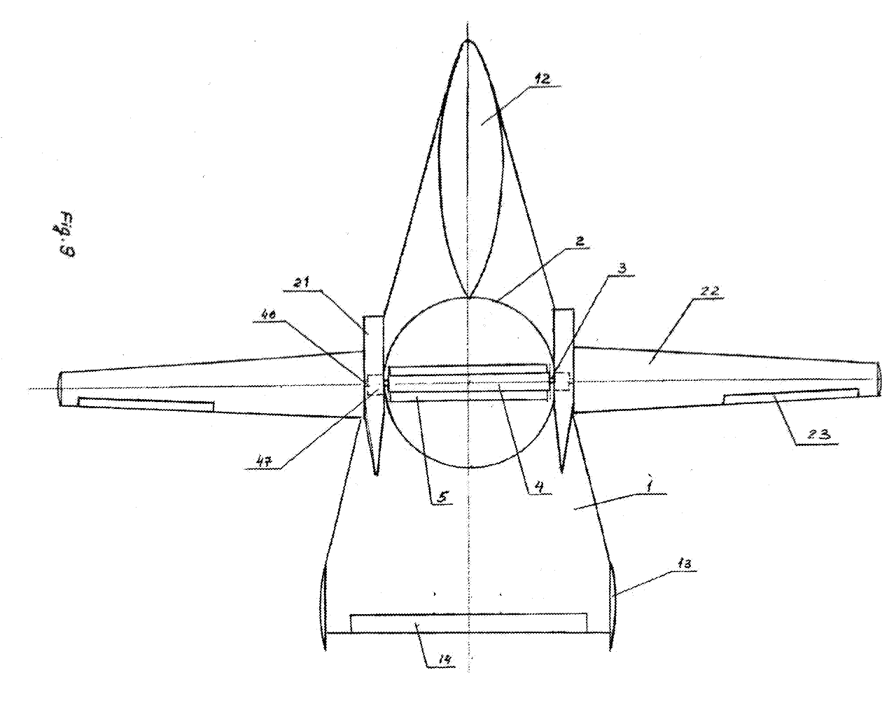

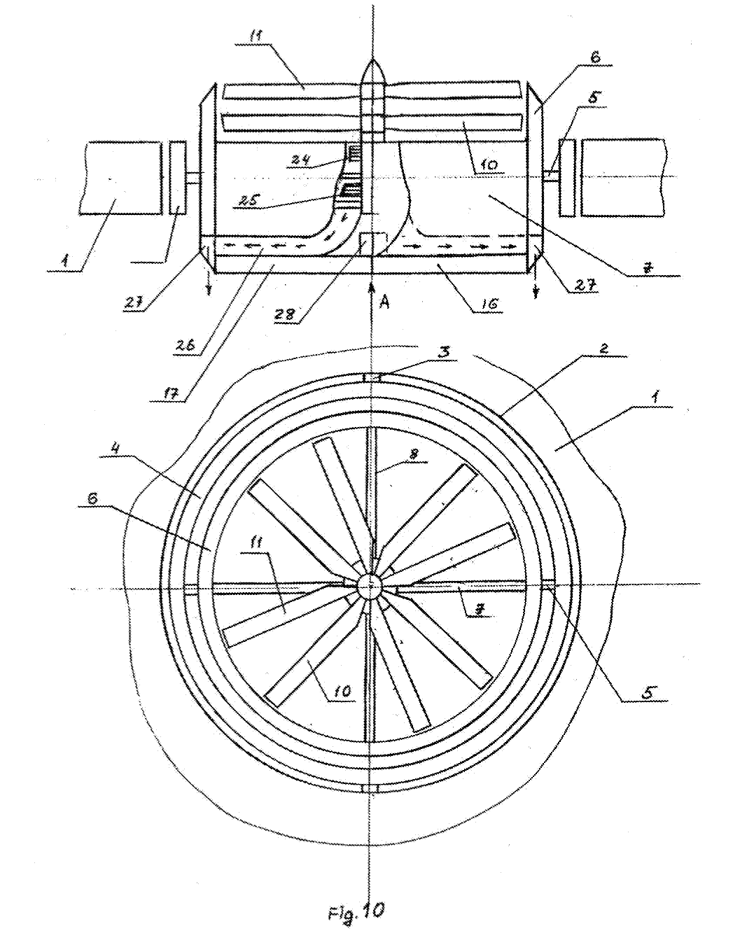

FIGS. 8 and 9 show respectively a front view and a plan view of a third embodiment of the convertible aircraft;

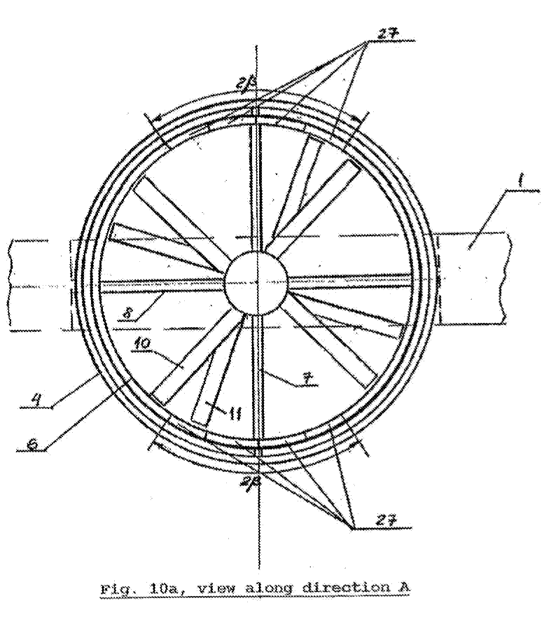

FIG. 10 shows a plan view and a cross-sectional view of the propulsion apparatus of the convertible aircraft with a turbo-propeller engine;

FIG. 10a shows a view along direction A of the propulsion apparatus of FIG. 10;

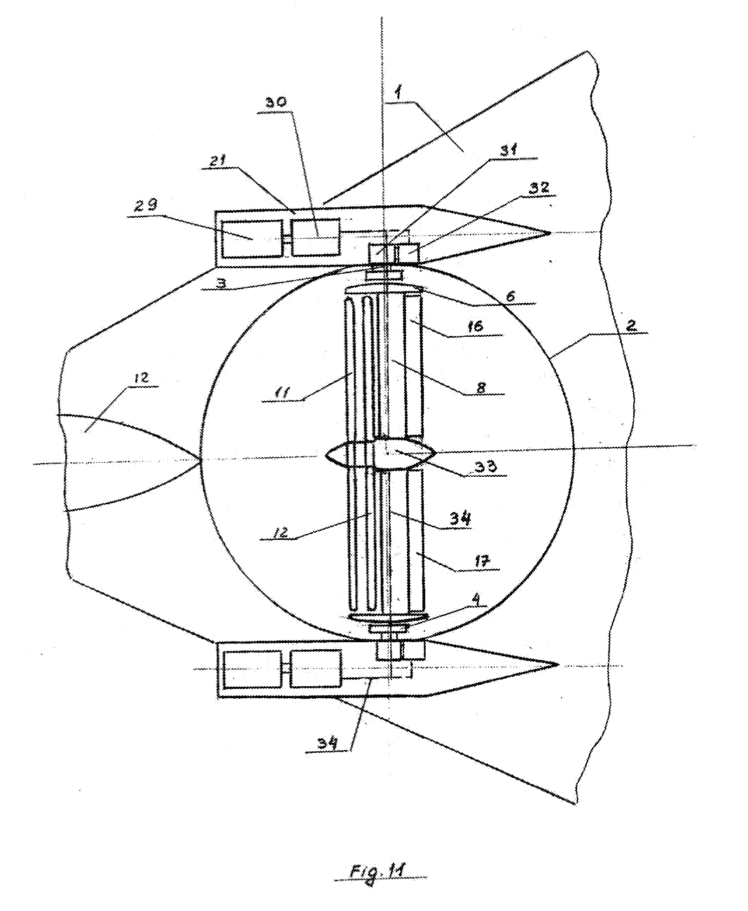

FIG. 11 shows a schematic plan view of the power units, and of the operation devices of the propulsion apparatus of the convertible aircraft;

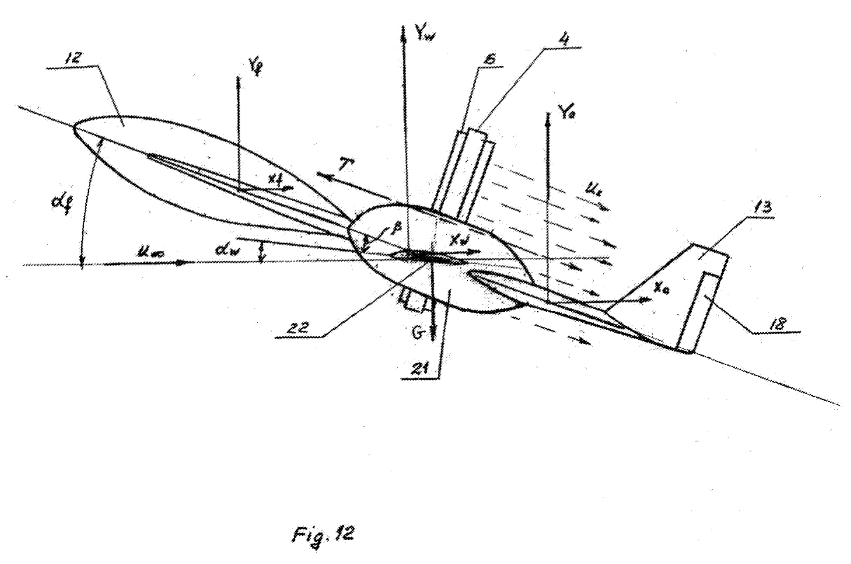

FIG. 12 shows a side view of the convertible aircraft with the schematics of the aerodynamic forces;

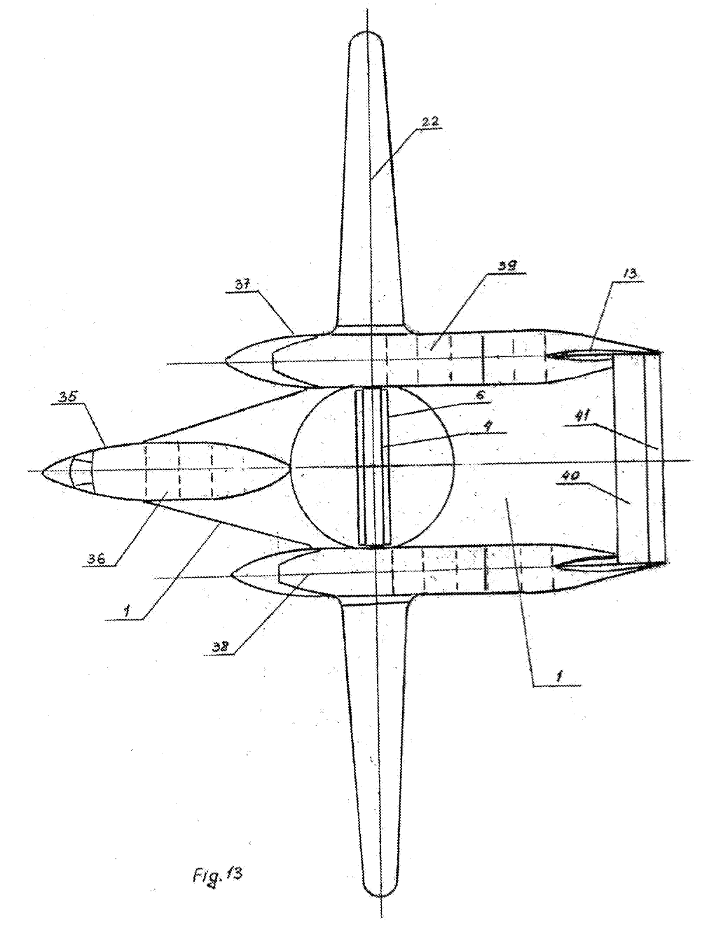

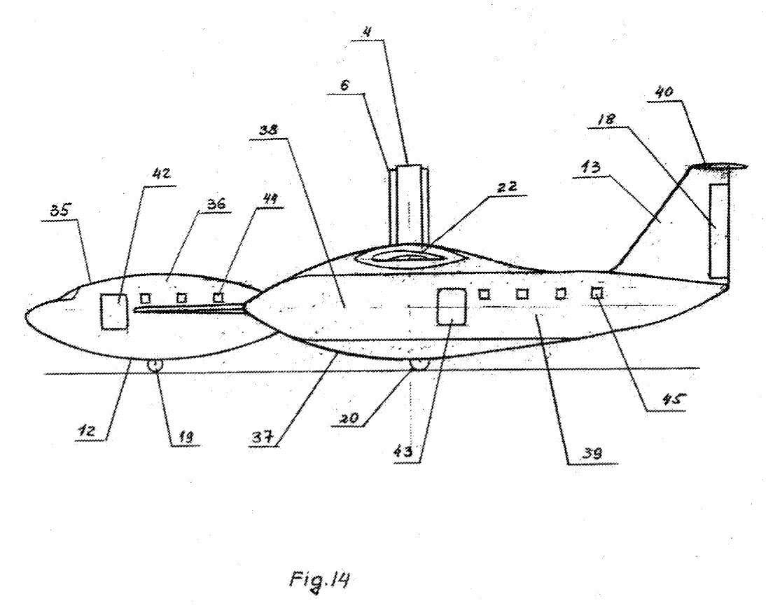

FIGS. 13 and 14 show respectively: a plan view and a side view of an embodiment of the convertible aircraft with three fuselages.

Referring to FIGS. 1 to 4, there may be seen a first embodiment of the triangular-wing convertible aircraft, mainly comprising:

a triangular wing 1, a front fuselage 12, two fins 13, each with rudder 18, elevator 14 manufactured in two sections, which may also serve as ailerons, two nacelles 15 comprising the main landing gears 20 and electromechanic control devices. The wing 1 has a circular hole 2 with the center corresponding with the center of gravity of the aircraft. Inside the hole 2 an external ring 4 is hung to the horizontal and transversal hinges 3. Inside the external ring 4 the air sucking ring 6 is hung to the longitudinal hinges 5.

At the center of the ring 6 it is located the propulsor nacelle 9, which is fixed to the structure of the section beams 7 and 8. The axes of the section beams 7 and 8 are substantially perpendicular. The beams 7 and 8 are rigidly connected with the ring 6. Referring to FIG. 2, the convertible aircraft has two coaxial contra-rotating rotors 10 and 11. Each rotor has a variable-pitch four-blade propeller. The external ring 6 may be installed with the aid of electromechanic apparatuses at the angle ω with respect to the XZ plane of the wing 1. The angle ω is the angle between propulsion vector (thrust) on XY plane and Y axis perpendicular to the XZ plane of the wing 1. For vertical takeoff, ω=O. For flight under maximum speed conditions, ω=90°. Theoretically, angle ω may range from O to ±180°. The propulsion vector (thrust) may be tilted with the aid of electromechanic mechanisms to the angle γ on YZ plane with respect to Y axis. The control of the angles ω and γ of the propulsion vector provides for the significant increase of stability and maneuverability of the convertible aircraft under all flight conditions: under helicopter conditions and under airplane conditions. The great advantage of the convertible aircraft according to the present invention is that the propulsion vector (thrust) always runs through the center of gravity of the aircraft, whereas the direction of this vector is variable. The ailerons 16 and 17 at the beam 7 and 8 serve for accurate control of the aircraft during vertical takeoff and landing and during low-speed flight, low speed at which other aerodynamic control means are not effective. The convertible aircraft in the embodiment corresponding to FIGS. 1 to 4 can take off and land as helicopter and fly as airplane at maximum speed in position ω=90° (FIG. 3). FIGS. 5, 6, 7 respectively show a plan view, a front view and a side view of the convertible aircraft with two pylons 21 installed on the wing above the nacelle 15; in this embodiment of the convertible aircraft, the axis of the transversal hinges 3 is raised with respect to the plane of the wing 1, so that the external ring 4 in vertical position (ω=90°) has a guaranteed gap with respect to the ground, as shown in FIGS. 6 and 7. In this embodiment the convertible aircraft can take off and land like a conventional airplane; this is useful to transport big loads (cargo). The convertible aircraft according to the present invention can fly with a large angle of attack, as the rotors in position (ω=90°) provide to convey air in a sufficiently fast amount onto the top surface of the wing 1 to prevent air flow detachment from the surface of the wing 1. The convertible aircraft in the embodiment shown in FIGS. 5 and 6 may carry out short-distance takeoff and landing by positioning the rotor at angle ω=90°-110°. FIGS. 8 and 9 show respectively: a front view and a plan view of an embodiment of the convertible aircraft for long-distance and/or long-lasting flights and/or option of big load (cargo) transport. In this embodiment, the convertible aircraft comprises a second wing 22 with larger span: the left and right portions of the wing 22 are connected with the structure of the pylons 21 through hinges 46 which serve for adjusting the pitch of the wing 22 with respect to the plane of the wing 1. The electromechanisms 47 serve for controlling the pitch of the wing 22. The triangular wing 1 in this embodiment of the convertible aircraft may have the span less extended (FIG. 5) than the two first embodiments of the convertible aircraft of FIGS. 1 and 5. The wing 1 in FIG. 9 has the elevator 14, and ailerons 23 placed on the wing 22. FIGS. 10 and 10a show a schematic drawing of installation of a turbo-propeller engine fixed to the section-formed structure of the beams 7 and 8. 24 axial compressor, 25 turbine, 7 exhaust gas ducts inside the beam structure, 27 sectorial outlet chamber for exhaust gases. FIG. 10a shows a view taken along direction A (FIG. 10) where there are four chambers 27 for outletting exhaust gases into the structure of the ring 6. Angle γ must not exceed 30° of tilt in order to eliminate chances of contact between surfaces of the wing 1 and exhaust gases. The surfaces of the wing 1, in this configuration, are kept apart from the exhaust gases by the large air layer generated by the propellers. FIG. 11 shows a schematic plan view of the propulsion system with an electric motor installed in the nacelle 33, and of the coaxial contra-rotating rotors 11 and 12. Two power units 29 (motor)—30 (generator) are installed inside the nacelles of the pylons 21, electric cables run inside the structure of the section bar 8 and join the electric motor of the nacelle 33. Electric motors 32 and reduction gears 31 serve for controlling the angle ω of the propulsion vector (thrust). Alike electromechanic mechanisms, which serve for controlling the angle γ, are installed in the structure of the external ring 4. The use of the electric motor for propeller can significantly decrease aircraft weight, simplify propeller control and increase flight safety, since in case of breakage of one of the two power units it creates no serious danger to aircraft flight.

FIG. 12 shows an aerodynamic scheme of the convertible aircraft:

Y_{W}—lift of wing 22,
X_{W}—aerodynamic drag of wing 22,
Ya and Xa are respectively lift and aerodynamic drag of the wing 1
Yf and Xf are respectively lift and aerodynamic drag of the front fuselage 12 with the front portion of the wing 1.
G—aircraft weight
13—fin with rudder 18.
u_{∞}—relative speed of air during flight.
α_{f}—angle of attack of the wing 1.
α_{w}—angle of attack of the wing 22.
T—propulsion vector (thrust),
β=α_{f}−α_{w}

During flight, all aerodynamics, inertial, thrust and weight are in balance. The convertible aircraft according to the present invention can fly at low speed u_{∞} at the large angle α_{f} producing sufficient lift as the top surface of the wing 1 remains under the air flow of the propeller with a speed uᵣ, and the wing 22 remains at the angle of attack with optimal α_{w} which is much smaller than α_{f}. FIGS. 13 and 14 show respectively a plan view and a side view of the convertible aircraft with passenger cabins, wherein;

35—cockpit,
36,39—passenger cabins,
39—power unit compartment,
37—lateral fuselage,
1—small-span wing,
22—large-span wing,
4 and 6—external ring and air sucking ring of the propeller (coaxial rotors), respectively
13—fin,
18—rudder,
40—horizontal tail surface,
41—elevator,
42,43—front door and rear door, respectively
44,45—passenger cabin windows.

In this embodiment the convertible aircraft has three fuselages: a front fuselage with two lateral fuselages (37) with power unit compartments (38) and passenger cabins (39). The three fuselages of the aircraft are dimensioned so that the center of gravity of the aircraft coincides with the center of the propulsion system (rings 4 and 6). The span of the wing 1 is equal to the diameter of the ring 4 of the propulsion system. The most important features of the convertible aircraft can be calculated for each of the above-mentioned embodiments thereof. The thrust of the propulsion system may be calculated with the following formula:

T=χ₁ρω²D⁴, in kg

### Wherein:

ρ—air density at flight altitude, (kgsec²/m⁴)
ω—angular velocity of rotors, (rad/sec)
D—rotor diameter, (m)
χ₁—non-dimensional coefficient, which depends on the aerodynamic features of the rotor.

The motor power required to produce the thrust T may be calculated with the following Formula:

W=χ₂ρω³D⁵, (kgm/sec)

wherein:
χ₂—non-dimensional coefficient, which depends on χ₁ and other aerodynamic features of the rotors. During vertical takeoff, T=G, where G is the aircraft weight.

W/G=W/T=χ₃ωD

Where χ₃=χ₁/χ₂.

In Aerospace Source Book 2006 (Aviation Week & Space Technology, Jan. 16, 2006), there have been published all technical data related to present-day helicopters and tilt rotors. By analyzing these data we can conclude that, statistically, for heavy- and medium-weight helicopters W/G≈37.5 m/sec. For light-weight helicopters W/G≈22.5 m/sec. These data correspond to ω=12 1/sec or frequency f=2 rps (120 rpm). Another interesting parameter is the load per air unit of the rotor:

p=4G/πD², (kg/m²)

By analyzing the data in Aerospace Source Book 2006 we can conclude that, statistically, for heavy- and medium-weight helicopters p≈40 kg/m²; for light-weight helicopters p≈20 kg/m²; for V22 Osprey p≈120 kg/m²; for BA609 p≈80 kg/m². The BA609 convertiplane has the rotor with D=8 m and a weight G=7476 kg.

The V22 convertiplane has the rotor with D=11.4 m, and a weight G=24475 kg.

From the preceding formulas there ensues

p=4G/πD²=4T/πD²=(4χ₁ρ/π)(ωD)²

From the statistical data we have seen that value (ωD) is constant for the group to which the helicopter type belongs. (ωD) is greater for heavier helicopters, as the rotor diameter D increases.

The rotors of the convertiplanes V22 and BA 609 respectively have a diameter D smaller than the diameter of the helicopter rotor. In order to meet the value of parameter (p), which for helicopters is much greater than this parameter, the rotors of these convertiplanes have a higher value of parameter ω(ω≈25 1/sec). The convertible aircraft according to the present invention in the embodiment shown in FIGS. 13,14 may have parameter ω and D similar to that for a heavy-weight helicopter. In the embodiment of light-weight UAV/UCAV aircraft corresponding to FIGS. 1,3,4 and 5,6,7, and 8,9, the convertible aircraft may have smaller rotor diameter and higher angular velocity ω.

From experimental research conducted by TsAGI (Central Aerohydrodynamic Institute, Zhukovski, Russia) it is known that a propulsor containing the propeller inside a ring can yield a 40% to 120% increase of the thrust.

Thus, a convertiplane according to the configuration proposed by us will exhibit a considerable increase of the thrust during takeoff and landing.

Rotor diameter decreases at the increasing of the number of blades.

It is important to optimize the rotation speed (rpm) of the rotors by means of the speed changing system.

During cruising flight, the power required for propulsion in a substantially horizontal flight may be 10 times less than the power required for vertical takeoff.

Therefore, fuel consumption during a substantially horizontal flight decreases significantly, providing the option of a prolonged cruising range.

Table 1 shows the potential features of the convertible aircraft in different embodiments thereof.

TABLE 1

| | | Aircraft embodiments | | | |
|---|---|---|---|---|---|
| | | | | | Aircraft |
| | | Micro | Mini | UAV/UCAV | with 20-25 |
| N^{o} | Aircraft features | UAV | UAV | light aircraft | persons |
| 1 | load bearing | 2-5 | 40-100 | 150-300 | 2000 |
| | for vertical takeoff, | | | | |
| | Kg | | | | |
| 2 | Max. load at takeoff, | 27 | 400 | 1500 | 18000 |
| | Kg | | | | |
| 3 | Rotor diameter, m | 0.5-0.6 | 2-2.4 | 3.7-4.6 | 13-16 |
| 4 | Motor power, kW | 10 | 120 | 470 | 2 × 3750 |
| 5 | Max. time of flight, | 25-50 | 29-58 | 30-60 | 30 |
| | h. | | | | |
| 6 | Maximum flight | 2500 | 4800 | 7000 | 7000 |
| | distance, km | | | | |
| 7 | Cruising speed; | 100 | 160 | 250 | 250 |
| | km/h | | | | |
| 8 | Max. speed, km/h | 150 | 320 | 500 | 500 |

From the data in Table 1 it follows that the convertible aircraft exhibits, in all of its embodiments, technical features much more advantageous than those of present-day aircrafts.

1. An aircraft, comprising:
a) a main body comprising at least one substantially triangular wing, said main body including a recess centered substantially in correspondence of the center of gravity of said aircraft;
b) a propulsion system adapted to selectively pivot within said recess with respect to said main body, said propulsion system comprising:
b1) a thrust rotor system;
b2) main motor means for operating said thrust rotor system; and
b3) adjusting means for adjusting pivoting of said propulsion system with respect to said main body, adapted to change tilt of a thrust developed by said thrust rotor system;
wherein tilt of an axis of rotation of said thrust rotor system is variable in association with said pivoting so that the thrust instantaneously developed thereby is vectorially passing through said center of gravity of said aircraft, particularly during vertical take-off,
c) a front fuselage, mounted frontally to said main body; and
d) two lateral fuselages, mounted substantially above said wing and connected to said main body substantially symmetrically with respect to a substantially longitudinal axis of said main body.

2. The aircraft according to claim 1, wherein said substantially triangular wing is a delta wing.

3. The aircraft according to claim 1, wherein said thrust rotor system comprises twin counter-rotating rotors.

4. The aircraft according to claim 3, wherein said twin rotors comprise two counter-rotating propellers.

5. The aircraft according to claim 1, wherein said propulsion system is connected to said main body by a gimbal system.

6. The aircraft according to claim 5, wherein said gimbal system comprises an external ring rotatably connected to said main body through transversal hinges and an internal ring rotatably connected to said external ring through longitudinal hinges.

7. The aircraft according to claim 6, wherein a rotation of said external ring about said transversal hinges by said adjusting means causes a proportional rotation of a first angle of said thrust rotor system about a substantially transversal axis of said main body.

8. The aircraft according to claim 6, wherein a rotation of said second internal ring about said longitudinal hinges by said adjusting means causes a proportional rotation of a second angle of said thrust rotor system about the substantially longitudinal axis of said main body.

9. The aircraft according to claim 6, wherein an axis of rotation of said transversal hinges is substantially perpendicular to said substantially longitudinal axis of said main body and vectorially passes through said center of gravity of said aircraft.

10. The aircraft according to claim 6, wherein an axis of rotation of said longitudinal hinges is substantially perpendicular to an axis of rotation of said transversal hinges.

11. The aircraft according to claim 1, wherein said main motor means is integrated in a motor nacelle and associated through a rotary shaft to said thrust rotor system.

12. The aircraft according to claim 11, wherein said propulsion system is connected to said main body by a gimbal system, said motor nacelle being integral with said gimbal system.

13. The aircraft according to claim 12, wherein said gimbal system comprises an external ring rotatably connected to said main body through transversal hinges, and an internal ring rotatable connected to said external ring through longitudinal hinges, wherein said motor nacelle is integral with said internal ring through substantially beam-shaped structural members.

14. The aircraft according to claim 6, wherein said adjusting means comprises electromechanic means of rotation of said external ring and of said internal ring.

15. The aircraft according to claim 14, wherein said electromechanic means of rotation comprises reduction gears and electric motors in cooperation with said transversal and longitudinal hinges.

16. The aircraft according to claim 1, wherein said main motor means is a turbo-propeller.

17. The aircraft according to claim 6, wherein said main motor means is a turbo-propeller, wherein said gimbal system comprises an air inlet for sucking comburent air for said turbo-propeller.

18. The aircraft according to claim 17, wherein said air inlet is comprised in said internal ring.

19. The aircraft according to claim 13, wherein said main motor means is a turbo-propeller, said turbo-propeller comprising a compressor, a turbine, and exhaust gas ducts one of the beam-shaped structural members.

20. The aircraft according to claim 19, comprising outlet chambers for said exhaust gas ducts, comprised in said internal ring.

21. The aircraft according to claim 20, wherein said outlet chambers are positioned inside an angular sector of said second internal ring comprised in a range from +30° to −30° with respect to an axis of the one of the beam-shaped structural members.

22. The aircraft according to claim 13, further comprising ailerons applied on said substantially beam-shaped structural members, said ailerons being controllable by control means installed on said motor nacelle.

23. The aircraft according to claim 7, wherein said transversal hinges are installed on pylons mounted above said wing, at a height such that, with regard to an arrangement of the rotation of any value of said first angle of said thrust rotor system about the substantially transversal axis of said main body, said external ring is spaced from a takeoff/landing surface for all configurations of said external ring.

24. The aircraft according to claim 23, wherein said external ring is spaced from the takeoff/landing surface when in a configuration corresponding to said first angle being substantially equal to 90°.

25. The aircraft according to claim 23, wherein said pylons are two and arranged substantially symmetrically with respect to the substantially longitudinal axis of said main body.

26. The aircraft according to claim 25, further comprising an additional, substantially trapezium-shaped, wing, said additional wing being attached to each of said two pilons.

27. The aircraft according to claim 26, wherein a pitch angle of said additional wing is adjustable through a transversal hinge connected to an actuation device.

28. The aircraft according to claim 1, wherein said main motor means is an electric motor means.

29. The aircraft according to claim 23, wherein said main motor means is an electric motor means electrically connected through transmission lines with power units installed on respective nacelles.

30. The aircraft according to claim 29, wherein said power units comprise a motor and a generator.

31. The aircraft according to claim 1, wherein on said two lateral fuselages respective fins are installed, connected there between by a common horizontal tail surface.

32. The aircraft according to claim 1, comprising a substantially tricycle landing gear, said landing gear comprising a front wheel placed beneath said front fuselage and two rear wheels respectively placed beneath said two lateral fuselages and extractable from respective nacelles.

33. The aircraft according to claim 1, wherein said front fuselage comprises a cockpit and a passenger cabin.

34. The aircraft according to claim 1, wherein each of said two lateral fuselages comprises a compartment adapted to house a power unit and a passenger cabin.

35. The aircraft according to claim 1, wherein said front fuselage and said two lateral fuselages comprise a watertight bottom adapted to allow in-water translation of said aircraft.

36. The aircraft according to claim 33, wherein said passenger cabin is convertible to at least one between a cargo transport, a cistern, and a tank device.
